(19) United States
(12) Patent Application Publication
(10) Pub. No.: US 2006/0099365 A1
(43) Pub. Date: May 11, 2006

(54) Joint part for resin fuel tank and manufacturing method thereof

(75) Inventors: Kensuke Sasai, Kasugai-shi (JP); Kazutaka Katayama, Kasugai-shi (JP); Junichiro Suzuki, Kasugai-shi (JP); Hiroaki Ito, Komaki-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: TOKAI RUBBER INDUSTRIES, LTD., Komaki-shi (JP)

(21) Appl. No.: 11/258,099

(22) Filed: Oct. 26, 2005

(30) Foreign Application Priority Data
Sep. 27, 2005 (JP) JP2005-280270
Oct. 26, 2004 (JP) JP2004-310324

(51) Int. Cl. B32B 27/08

(52) U.S. Cl. 428/35.7; 428/36.9

(57) ABSTRACT

A joint part 1 excellent in both properties of low fuel permeability and weldability. The joint part 1 includes a cylindrical main body 2, a welding member 3, provided on the cylindrical main body, to be welded on a rim of an opening end of a resin fuel tank 4, wherein the main body and the welding member are integrally formed by an alloy prepared by using main components of following components (A) and (B) and kneading the alloy at a temperature of not more than melting points of the component (A) and a following component (b), and the component (B) is present at an amount of 80 to 300 parts by volume based on 100 parts by volume of the component (A), and a modification ratio of the component (b) is 0.1 to 5% by weight; (A) an ethylene vinyl alcohol copolymer (B) a high density polyethylene wherein a following component (b) is a main component; (b) a modified high density polyethylene having at least one functional group selected from the group consisting of a maleic anhydride group and the like.

### BACKGROUND OF THE INVENTION

1. Field of the Invention

This invention relates to a joint part for a resin fuel tank and a manufacturing method thereof. More particularly, it relates to any of joint parts, which may be in the form of, for example, a valve or pipe, attached to a resin fuel tank for connecting a fuel hose or the like to the resin fuel tank and a manufacturing method thereof.

2. Description of the Art

The integration of automotive parts has been recently promoted. For example, there has been an increase of cases in which connecting valves or pipes made of a resin, such as filler valves and onboard refueling vapor recovery (ORVR) fuel valves, are attached to an automobile fuel tank made of a resin for joining fuel hoses to it. An automobile fuel tank often has a multilayer wall including a layer formed of a material of low fuel permeability, such as an ethylene vinyl alcohol copolymer (EVOH), to cope with the recent gasoline evaporative emission regulations. It often has an outer surface layer formed of high density polyethylene (HDPE) for water resistance and economical reasons. A fuel filler valve is usually made of polyamide 12 reinforced with glass fiber (PA12GF) because of its low fuel permeability. Such a valve is, however, very low in weldability to the outer surface layer of HDPE of the fuel tank.

Therefore, there has been proposed a welding member interposed between the outer surface layer (for example, made of HDPE) of the tank and the filler valve (for example, made of PA12GF). The welding member is made of a material which is easily weldable to both of HDPE and PA12GF. For example, as shown in FIG. 6, a joint part 21 for a resin fuel tank has been proposed (for example, see Japanese Patent No. 2,715,870). The joint part 21 comprises a main body 22 having a flange 22a, and a welding member 23 to be welded to a resin fuel tank 24, wherein the main body 22 is formed by a resin, such as polyamide, having low fuel permeability and also the welding member 23 is formed by a polyethylene resin such as modified polyethylene resin or HDPE,

A polyethylene resin, such as modified polyethylene or HDPE, is, however, of high fuel permeability. Since fuel contained in the resin fuel tank 24 evaporates through the welding member 23, it has a defect of insufficient fuel permeability resistance.

### SUMMARY OF THE INVENTION

Accordingly, it is an object of the present invention to provide a joint part excellent in both properties of low fuel permeability and weldability, and a manufacturing method thereof.

To this end, according to a first aspect of the present invention, there is provided a joint part for a resin fuel tank comprising a cylindrical main body and a welding member to be welded to a rim of an opening end of the resin fuel tank, wherein the main body and the welding member are integrally formed for forming the joint part and formed by an alloy prepared by using main components of following components (A) and (B) and kneading the alloy at a temperature of not more than melting points of the component (A) and a following component (b), and the component (B) is present at an amount of 80 to 300 parts by volume based on 100 parts by volume of the component (A), and a modification ratio of the component (b) is 0.1 to 5% by weight;
(A) an ethylene vinyl alcohol copolymer
(B) a high density polyethylene wherein the following component (b) is a main component;
(b) a modified high density polyethylene having at least one functional group selected from the group consisting of a maleic anhydride group, a maleic acid group, an acrylic acid group, a methacrylic acid group, an acrylate ester group, a methacrylate ester group, a vinyl acetate group and an amino group.

According to a second aspect of the present invention, there is provided a method for manufacturing the above-mentioned joint part, comprising the steps of
preparing an alloy consisting essentially of a following component (A) and a following component (B),
kneading the prepared alloy with shearing at not more than melting points of the component (A) and a following component (b);
(A) an ethylene vinyl alcohol copolymer
(B) a high density polyethylene wherein the following component (b) is a main component;
(b) a modified high density polyethylene having at least one functional group selected from the group consisting of a maleic anhydride group, a maleic acid.group, an acrylic acid group, a methacrylic acid group, an acrylate ester group, a methacrylate ester group, a vinyl acetate group and an amino group.

To solve the problems described above, the present inventors have piled intensive studies to obtain a joint part attached to a resin fuel tank for connecting a fuel hose or the like to the resin fuel tank, which is excellent both in low fuel permeability and weldability. During their studies, they came up with the idea that a main body for connecting a fuel hose or the like to the resin fuel tank and a welding member to be welded onto the resin fuel tank are integrally formed by the same material, instead of being formed separately from each other from different materials, respectively, as in the conventional method. They made further studies on the material for forming the main body and the welding member and got the idea that an ethylene vinyl alcohol copolymer excellent in low fuel permeability and an alloy mainly composed of a modified polyolefin resin are used in combination. Based on the idea, they made repeated experiments on kinds, modification and modification ratios of the modified polyolefin resin, mixture ratios between the ethylene vinyl alcohol copolymer and the modified polyolefin resin, kneading temperatures and the like. As a result, they found that an alloy obtained by the following method is extremely effective. Such an alloy can be obtained by using a modified high density polyethylene having a specific functional group such as a maleic anhydride group and a maleic acid group, wherein the modification ratio is 0.1 to 5% by weight, preparing a high density polyethylene mainly composed of the modified high density polyethylene at a mixture ratio of 80 to 300 parts by volume based on 100 parts by volume of the ethylene vinyl alcohol copolymer, and kneading the resulting mixture at a temperature of not more than melting points of the ethylene vinyl alcohol copolymer and the high density polyethylene, When using such an alloy, even if the main body and the welding member are integrally formed, the above-mentioned object can be achieved. In detail, they found that when the ethylene vinyl alcohol copolymer and the specific modified high density polyethylene are used in combination and are kneaded with high shearing at a temperature of not more than melting points of both materials, an island-sea is obtained structure wherein micro particles comprising the specific modified high density polyethylene are evenly dispersed in a matrix comprising the ethylene vinyl alcohol copolymer. It is thought that a hydroxyl group of the ethylene vinyl alcohol copolymer and a modification group of the specific modified high density polyethylene form a hydrogen bond or a covalent bond. For this reason, an affinity between the ethylene vinyl alcohol copolymer and the specific modified high density polyethylene is increased so that the micro particles get to have extremely small diameters (about 1 μm) with almost no variation, resulting in uniform dispersion of micro particles. It is thought that the permeation amount of fuel is decreased and thus low fuel permeability becomes excellent, and also weld strength with the fuel tank is improved and thus weldability is improved. In addition, if the ethylene vinyl alcohol copolymer and the specific modified high density polyethylene are kneaded at a temperature exceeding melting points of both materials, an island-sea structure is reversed. That is, the specific modified high density polyethylene becomes a matrix, while the ethylene vinyl alcohol copolymer becomes dispersed particles and their diameters becomes 3 to 5 μm, which are not extremely micro particles, resulting in remarkably inferior fuel permeability.

As described above, in the present invention, the welding member to be welded onto the resin fuel tank is formed by the same material as the main body, that is, the alloy mainly composed of the ethylene vinyl alcohol copolymer and the specific modified high density polyethylene. For this reason, an affinity between the ethylene vinyl alcohol copolymer and the specific modified high density polyethylene is increased. Also, these materials are kneaded with shearing at a temperature of not more than melting points of both materials, so that the micro particles get to have extremely small diameters (about lum) with almost novariation, resulting in uniform dispersion of micro particles. As a result, the permeation amount of fuel is decreased and thus low fuel permeability becomes excellent, and also weld strength between the welding member to be attached to the resin fuel tank and the outer surface material (usually made of HDPE) of the resin fuel tank is improved, and further weld strength between the welding member to be attached to the resin fuel tank and a valve member such as a valve housing (usually made of glass-reinforced polyamide) to be attached to a lower part of the main body, as required, is improved, and thus weldability is improved. In the case where the welding member of the joint part is made of a modified polyethylene resin or a polyethylene resin such as HDPE, as described in Japanese Patent No. 2,715,870, fuel is easy to permeate so that the height for connecting the welding member with the joint part should be determined to control the permeation amount of fuel. However, according to the present invention, since the welding member comprises an ethylene vinyl alcohol copolymer and a specific high density polyethylene, which form an island-sea structure wherein micro particles (about lam) comprising the specific modified high density polyethylene are evenly dispersed in a matrix comprising the ethylene vinyl alcohol copolymer, the welding member is excellent in low fuel permeability, resulting in the effect that there is no necessity of determination of such a height. Further, since the diameters of the particles dispersed therein are smaller, there is another effect that strength and impact resistance of the joint part for the resin fuel tank are increased. Still further, in the joint part for the resin fuel tank according to the present invention, the main body and the welding member are integrally formed by the above-rnentioned specific alloy. Therefore, since there is no necessity to connect the main body and the welding member by means of two-color molding or the like, as in the conventional method, mold cost and molding cost can be lowered.

Where the joint part is integrally formed by an alloy prepared by including an inorganic filler (preferably, glass fiber) in addition to the ethylene vinyl alcohol copolymer and the specific high density polyethylene, the strength of the joint part is increased. For this reason, permanent set, caused by clamp force or the like, of the joint part can be restrained, a hose or the like connected with the main body becomes hard to be separated from the joint part, and thus a sealing property is further improved.

Where the joint part is integrally formed by an alloy prepared by including a compatibilizer in addition to the ethylene vinyl alcohol copolymer and the specific high density polyethylene, even if the specific high density polyethylene having a modification ratio near to the lower limit (0.1% by weight) is used, the effect that the diameters of the particles become extremely small is realized.

Where stress at yield point or tensile strength at break of the alloy is not less than 20 MPa, which is over stress at yield point of the outer surface material of the resin fuel tank, deformation or collapse of the joint part may not occur prior to that of the tank material, resulting in increased reliability in terms of low fuel permeability,

### BRIEF DESCRIPTION OF THE DRAWINGS

FIG. 1 is a sectional view illustrating one example of a joint part for a resin fuel tank according to the present invention;

FIG. 2 is a sectional view illustrating a test joint part used for evaluation in Examples and Comparative Examples;

FIG. 3 is a sectional view illustrating a measuring method of a permeation amount of fuel in Examples and Comparative Examples;

FIG. 4 is a scanning electron micrograph illustrating a morphological structure of Example 2;

FIG. 5 is a scanning electron micrograph illustrating a morphological structure of Comparative Example 14; and

FIG. 6 is a sectional view illustrating a conventional joint part for a resin fuel tank.

### DESCRIPTION OF THE PREFERRED EMBODIMENTS

The present invention will be described in detail below.

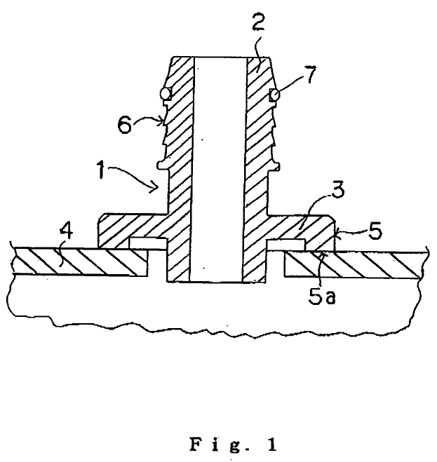

The joint part of the present invention may have a structure, for example, as shown in FIG. 1. The joint part 1 comprises a main body 2 having an approximately cylindrical form and a welding member (a flange) 3 laterally extended from the lower periphery of the main body 2. The welding member 3 includes a wall 5 perpendicularly extended from the outer periphery thereof. A bottom surface 5a of the wall 5 is welded to a rim of an opening end of a resin fuel tank 4. A junction 6 is formed at a distal end of the main body 2 to help prevent a connected hose (not shown) from being separated therefrom. In FIG. 1, a reference numeral 7 indicates an O-ring for increasing air tightness (sealing property). There is no problem if the O-ring 7 is not specially installed, however, it is preferred that the O-ring 7 is installed in terms of air tightness.

The fuel tank, to be welded onto the welding member 3, in this invention is not limited to a tank 4 having a single-layer wall of a resin, as shown in FIG. 1, but may be a multilayer wall as long as at least a rim of an opening end of the tank is made of a resin (for example, HDPE). The fuel tank 4 is typically a gasoline tank for an automobile, though it may also be used for a different kind of fuel tank for a different purpose. A part to be connected with the junction 6 at the end of the main body 2 is not specifically limited and examples thereof include a fuel hose, an onboard refueling vapor recovery (ORVR) hose, a filler hose, an evaporation hose. A method for welding the welding member 3 to the rim of the opening end of the tank 4 is not specifically limited, but may preferably be a heating plate welding method, a vibration welding method, an ultrasonic welding method or a laser welding method, because high weld strength can be obtained. However, a hot gas welding method or a spin welding method may also be employed.

In the present invention, the joint part 1 for the resin fuel tank is formed by the alloy prepared by using main components of the following components (A) and (B) and kneading the alloy at a temperature of not more than melting points of the component (A) and the following component (b), and the component (B) is present at an amount of 80 to 300 parts by volume based on 100 parts by volume of the component (A), and the modification ratio of the component (b) is 0.1 to 5% by weight, which are the main features of the present invention;
(A) an ethylene vinyl alcohol copolymer
(B) a high density polyethylene wherein the following component (b) is a main component;
(b) a modified high density polyethylene having at least one functional group selected from the group consisting of a maleic anhydride group, a maleic acid group, an acrylic acid group, a methacrylic acid group, an acrylate ester group, a methacrylate ester group, a vinyl acetate group and an amino group.

In the present invention, “main component” typically means a component occupying more than half, and also means a component occupying the entire.

The ethylene vinyl alcohol copolymer (EVOH) (component (A)) used for the joint part 1 of the present invention is not specifically limited However, EVOH having an ethylene proportion of 25 to 50 mol % is preferred. Particularly, EVOH having an ethylene proportion of 30 to 45 mol % is more preferred.

Further, EVOH (component (A)) having a melting point (Tm) of 160 to 191° C. is preferred, and particularly, EVOH having a melting point (Tm) of 165 to 185° C. is more preferred. Still further, EVOH having a melt flow rate (MFR) of 3 to 15 g/min (at 210° C., 2.16 kg) is preferred, and particularly, EVOH having a melt flow rate (MFR) of 3.5 to 14 g/min (at 210° C., 2.16 kg) is more preferred.

Together with the EVOH (component (A)), the specific high density polyethylene (HDPE) (component (B)) is used. In the present invention, the high density polyethylene (HDPE) means that its specific gravity is usually 0.93 to 0.97, and more preferably, 0.93 to 0.96, and also its melting point is 120 to 145° C. The specific gravity is in accordance with ISO 1183 and the melting point is in accordance with ISO 3146.

The specific HDPE (component (B)) is not specifically limited, as long as the above-mentioned specific modified HDPE (component (b)) is a main component thereof. For example, the component (B) may be composed of the specific modified HDPE (component (b)) only, or may be composed of the specific modified HDPE (component (b)) and HDPE other than the component (b), for example, non-modified HDPE in combination. Where the component (b) and HDPE other than the component (b) are used in combination, the mixing ratio (by volume) is preferably component (b)/HDPE other than component (b)=99/1 to 70/30, more preferably, component (b)/HDPE other than component (b)=99/1 to 90/10.

In the present invention, the specific HDPE (component (8)) should be present in an amount of 80 to 300 parts by volume (hereinafter just abbreviated to “parts”), preferably in an amount of 100 to 250 parts, based on 100 parts of the above EVOH (component (A)). When the mixing amount of the specific HDPE (component (B)) is less than 80 parts, weldability between the resin fuel tank and the welding member is inferior. When the mixing amount of the specific HDPE (component (B)) exceeds 300 parts, low fuel permeability is deteriorated.

Further, a melting point (ISO 1183) of the specific modified HDPE (component(b)) is preferably 126 to 1400° C., and particularly preferably, 128 to 136° C.

In the present invention, the specific modified HDPE (component (b)) is obtained, for example, by graft-modifying at least one of unsaturated carboxylic acid and unsaturated carboxylic acid derivative, or an amine-containing compound (such as methylene diamine) with HDPE in the presence of radical initiator.

Examples of the unsaturated carboxylic acid include, for example, monobasic unsaturated carboxylic acid and dibasic unsaturated carboxylic acid. Examples of the unsaturated carboxylic acid derivative include, for example, metallic salts, amides, imides, esters and anhydrides of unsaturated carboxylic acid. The carbon number of the monobasic unsaturated carboxylic acid and its derivative is 20 at a maximum, preferably, not more than 15. The carbon number of dibasic unsaturated carboxylic acid and its derivative is 30 at a maximum, preferably, not more than 25. Among unsaturated carboxylic acid, acrylic acid, methacrylic acid, maleic acid, 5-norbornene-2,3-dicarboxylic acid are preferred. Among unsaturated carboxylic acid derivative, acid anhydrides are preferred, particularly, acrylic anhydride, methacrylic anhydride, maleic anhydride, 5-norbornene-2,3-dicarboxylic anhydride are more preferred.

Examples of the radical initiator include, for example, organic peroxides such as dicumyl peroxide, benzoyl peroxide, di-t-butyl peroxide, 2,5-dimethyl-2,5-di(t-butyl peroxy)hexane, 2,5-dimethyl-2,5-di(t-butyl peroxy)hexyne, 2,5-dimethyl-2,5-di(t-butyl peroxy)hexane-3, lauroyl peroxide and t-butyl peroxy benzoate.

Exemplified methods for the graft modification include, for example, a melt kneading method wherein HOPE, a compound for modification such as unsaturated carboxylic acid and radical initiator are kneaded in a molten state by a kneading means such as an extruder, a BANBURY mixer or a kneader and a solution method wherein HDPE, a compound for modification such as unsaturated carboxylic acid and radical initiator are dissolved into suitable solvent. The method is appropriately decided on the application of the end-product joint part. Further, to improve physical properties of the specific modified HDPE (component (b)), for example, an unreacted monomer or a by-product material of unsaturated carboxylic acid and unsaturated carboxylic acid derivative may be eliminated by heating or cleaning after graft-modification.

The temperature for graft-modification is decided depending on temperature for deteriorating HDPE, kick-off temperature of unsaturated carboxylic acid or its derivative, kick-off temperature of radical initiator for use. For example, the temperature for the above-mentioned melt kneading method is usually 200 to 350° C., preferably 220 to 300° C., more preferably 250 to 300° C.

The modification ratio of the specific modified RDPE (component (b)) should be 0.1 to 5% by weight, as described above, preferably 0.1 to 3% by weight. When the modification ratio is less than 0.1% by weight, the affinity between the EVOH (component (A)) and the specific modified HDPE (component (b)) is deteriorated, and weldability and low permeability are inferior. On the contrary, when the modification ratio exceeds 5% by weight, low fuel permeability is inferior and work environment for kneading, molding and the like is deteriorated.

In the present invention, the modification ratio means how much (% by weight) the structural portion derived from the compound for modification such as unsaturated carboxylic acid accounts for based on the total amount of the specific modified HDPE (component (b)). The modification ratio is near to the ratio of the compound for modification in the raw material, such as unsaturated carboxylic acid (such as maleic acid). In other words, when the ratio of the compound for modification such as unsaturated carboxylic acid (such as maleic acid) is 0.1 to 5% by weight and the ratioof HDPE is 95 to 99.9% by weight in the raw material, it may well be that the modification ratio of the specific modified HDPE (component (b)) is 0.1 to 5% by weight.

In the present invention, the alloy mainly composed of the EVOH (component (A)) and the specific HDPE (component (B)) may be reinforced by an inorganic filler in terms of permanent set resistance.

Examples of the inorganic filler include glass fiber (GF), carbon fiber (CF), talc and mica. These may be used either alone or in combination thereof. Among them, glass fiber is preferred, especially, E-glass fiber is more preferred in terms of excellent permanent set resistance and cost effectiveness.

The content of the inorganic filler is preferably 5 to 50% by weight, particularly preferably 10to 45% by weight based on the entire alloy mainly composed of the EVOH (component (A)) and the specific HDPE (component (B)) in terms of permanent set resistance.

Further, the alloy may include a compatibilizer in addition to the EVOH (component (A)) and the specific HDPE (component (B)) in terms of low fuel permeability.

Examples of the compatibilizer include, for example, an ethylene-glycidyl methacrylate copolymer (EGMA), a modified EGMA, an ethylene-glycidyl methacrylate-vinyl acetate copolymer, an ethylene-glycidyl methacrylate-methyl acrylate copolymer, an ethylene-methyl acrylate copolymer, an ethylene-methyl acrylate-acrylate copolymer, an ethylene-ethyl acrylate copolymer (EEA), a modified EEA, a modified ethylene-ethyl acrylate-maleic anhydride copolymer, an ethylene-methacrylate copolymer, an acrylic rubber, an ethylene vinyl acetate copolymer (EVAc), a modified EVAc, modified polypropylene (PP), modified polyethylene (PE), an ethylene-ester acrylate-maleic anhydride copolymer, an epoxidized styrene-butadiene-styrene block copolymer (epoxidized SBS), an epoxidized styrene-ethylene-butylene-styrene block copolymer (epoxidized SEBS), an acid-modified SBS, an acid-modified SEBS, a styrene-isopropenyl oxazoline copolymer, a styrene-acrylonitrile-isopropenyl oxazoline copolymer and thermoplastic polyurethane, which may be used either alone or in combination.

Examples of a modified EGMA include, for example, those which are obtained by grafting polystyrene (PS), polymethyl methacrylate (PMMA), an acrylonitrile-styrene.copolymer (AS), a copolymer of PMMA and butyl acrylate, or the like, to EGMA.

Examples of a modified EEA include, for example, those which are obtained by grafting PS, PMMA, AS, a copolymer of PMMA and butyl acrylate, or the like, to EEA; a maleic anhydride modified EEA; and a silane modified EEl.

Examples of a modified ethylene-ethyl acrylate-maleic anhydride copolymer include, for example, those which are obtained by grafting PS, PMMA, AS, a copolymer of PMMA and butyl acrylate, or the like, to an ethylene-ethyl acrylate-maleic anhydride copolymer.

Examples of a modified EVAc include, for example, those which are obtained by grafting PS, PMMA, AS, a copolymer of PMMA and butyl acrylate, or the like, to EVAC.

Examples of a modified PP include, for example, those which are obtained by grafting PS or AS to PP, and a maleic anhydride modified PP.

Examples of the modified PE include, for example, those which are obtained by grafting PS, PMMA, AS, a copolymer of PMMA and butyl acrylate, or the like, to low-density polyethylene (LDPE).

The mixing ratio of the compatibilizer is preferably not more than 10% by weight relative to total amount of the alloy mainly composed of the EVOH (component (A)) and the specific HDPE (component (B)), particularly preferably 0.2 to 6% by weight.

As the alloy used for the joint part of the present invention, if the alloy is a material having an yield point, the stress at an yield point is preferably not less than 20 MPa, if the alloy is the material not having an yield point, the tensile strength at break is preferably not less than 20 MPa in terms of reliability. The stress at an yield point and the tensile strength at break can be measured in accordance with ISO 527.

The joint part 1 of the present invention may be produced, for example, by the following method. First, the EVOH (component (A)) and the specific HDPE mainly composed of the specific modified HDPE (component (b)) are prepared, and also an inorganic filler, a compatibilizer and the like, as required, are prepared, and are blended, and then are kneaded with shearing by means of a twin screw extruder at a temperature not more than melting points of the EVOH (component (A)) and the specific modified HDPE (component (b)) for preparation of the alloy. The thus prepared alloy is put into a mold having a specific shape for injection molding (preferably at 140 to 300° C.) to produce a joint part 1 (as shown in FIG. 1) for the resin fuel tank of the present invention, wherein the main body 2 and the welding member 3 are integrally formed.

The temperature for kneading is not specifically limited, as long as it is not more than melting points of the EVOH (component (A)) and the specific modified HDPE (component (b)), but is preferably 50 to 120° C., more preferably 60 to 100° C. When the kneading temperature exceeds melting points of the EVOH (component (A)) and the specific modified HDPE (component (b)), an island-sea structure is reversed That is, the specific modified HDPE (component (b)) becomes a matrix, while the EVOH becomes dispersed particles and their diameters become 3 to 5 μm, which are not extremely micro particles, resulting in remarkably inferior low fuel permeability.

The joint part 1 of the present invention is integrally formed of the main body 2 and the welding member 3. However, it may have a laminate structure including other materials such as high density polyethylene (HDPE), polyamide resin (PA) and the like.

The thus obtained joint part of the present invention may be applicable for, for example, fuel filler and ORVR valves, VSF (Vent Shaft Float) valve, V-return valve, but are not limited to valve type parts. Pipes for connecting hoses are applicable, too.

The method and the product of the present invention will be more fully understood from the following Examples along with Comparative Examples. However, the present invention is not limited to Examples.

The following materials were prepared prior to Examples and Comparative Examples.

EVOH (Component (A))

EvOH A to F having each properties (MFR, specific gravity, melting point, ethylene proportion) as shown in Table 1 were prepared.

TABLE 1

| | | | | | Specific | Melting | |
|---|---|---|---|---|---|---|---|
| | | | | MFR | Gravity | Point | Ethylene |
| ASTM | | | | D1238 | D1505 | D2117 | Proportion |
| Type | | Manufacturer | Product Name | g/10 min | g/cm³ | ° C. | Mol % |
| EVOH | A | KURARAY CO., LTD. | EVAL F101A | 3.8 | 1.19 | 183 | 32 |
| (Component | B | KURARAY CO., LTD. | EVAL H171B | 3.8 | 1.17 | 175 | 38 |
| (A)) | C | KURARAY CO., LTD. | EVAL E105B | 13 | 1.14 | 165 | 44 |
| | D | KURARAY CO., LTD. | EVAL G156 | 15 | 1.12 | 160 | 47 |
| | E | KURARAY CO., LTD. | EVAL F104B | 10 | 1.19 | 183 | 32 |
| | F | KURARAY CO., LTD. | EVAL L171B | 3.9 | 1.2 | 191 | 27 |

Maleic Anhydride-Modified HDPF-A (Component (b))

HDPE-A modified with maleic anhydride (modification ratio: 0.2% by weight, melting point: 129° C.) was produced by adding maleic anhydride (content: 0.2% by weight) and di-t-butyl peroxide (content: 1% by weight) to HDPE (NOVATEC HB111R available from Japan Polyethylene Corporation: specific gravity; 0.945, melting point; 129° C.), and melt kneading the thus obtained mixture by a twin screw extruder.

Maleic Anhydride-Modified HDPF-B (Component (b))

HDPE-B modified with maleic anhydride (modification ratio: 0.1% by weight, melting point: 129° C.) was produced by adding maleic anhydride (content: 0.1% by weight) and di-t-butyl peroxide (content; 1% by weight) to HDPE (NOVATEC HB111R available from Japan Polyethylene Corporation), and melt kneading the thus obtained mixture by a twin screw extruder.

Maleic Anhydride-Modified HDPE-C (Component (b))

HDPE-C modified with maleic anhydride (modification ratio: 5% by weight, melting point: 129° C.) was produced by adding maleic anhydride (content: 5% by weight) and di-t-butyl peroxide (content: 3% by weight) to HDPE (NOVATEC HBIlIR available from Japan Polyethylene Corporation), and melt kneading the thus obtained mixture by a twin screw extruder.

Maleic Anhydride-Modified HDPF-D (Component (b))

HDPE-D modified with maleic anhydride (modification ratio: 0.4% by weight, melting point: 135° C.) was produced by adding maleic anhydride (content: 0.4% by weight) and 2,5-dimethyl-2,5di(t-butyl peroxy)hexane (content: 0.015% by weight) to HDPE (NOVATEC HY430 available from Japan Polyethylene Corporation: specific gravity; 0.956, melting point; 135° C.), and melt kneading the thus obtained mixture by a twin screw extruder.

Maleic Anhydride-Modified HDPE-a

HDPE-a modified with maleic anhydride (modification ratio: 6% by weight, melting point: 129° C.) was produced by adding maleic anhydride (content: 6% by weight) and di-t-butyl peroxide (content: 3% by weight) to HDPE (NOVATEC HB111R available from Japan Polyethylene Corporation), and melt kneading the thus obtained mixture by a twin screw extruder.

Maleic Acid-Modified HDPE (Component (b))

HDPE modified with maleic acid (modification ratio: 0.3% by weight, melting point: 129° C.) was produced by adding maleic acid (content: 0.3% by weight) and di-t-butyl peroxide (content: 1% by weight) to HDPE (NOVATEC HB111R available from Japan Polyethylene Corporation), and melt kneading the thus obtained mixture by a twin screw extruder.

Acrylic Acid-Modified HDPE (Component (b))

HDPE modified with acrylic acid (modification ratio: 0.3% by weight, melting point: 129° C.) was produced by adding acrylic acid (content: 0.3% by weight) and di-t-butyl peroxide (content: 1% by weight) to HDPE (NOVATEC HB111R available from JapanPolyethylene Corporation), and melt kneading the thus obtained mixture by a twin screw extruder.

Methacrylic Acid-Modified HDPE (Component (b))

HDPE modified with methacrylic acid (modification ratio: 0.3% by weight, melting point: 129° C.) was produced by adding methacrylic acid (content: 0.3% by weight) and di-t-butyl peroxide (content: 1% by weight) to HDPE (NOVATEC HB111R available from Japan Polyethylene Corporation), and melt kneading the thus obtained mixture by a twin screw extruder.

Ester Acrylate-Modified HDPE (Component (b))

HDPE modified with ester acrylate (modification ratio: 0.3% by weight, melting point: 129° C.) was produced by adding methyl acrylate (content: 0.3% by weight) and di-t-butyl peroxide (content: 1% by weight) to HDPE (NOVATEC HB111R available from Japan Polyethylene Corporation), and melt kneading the thus obtained mixture by a twin screw extruder.

Ester Methacrylate-Modified HDPE (Component (b))

HDPE modified with ester methacrylate (modification ratio: 0.3% by weight, melting point: 129° C.) was produced by adding methyl methacrylate (content: 0.3% by weight) and di-t-butyl peroxide (content: 1% by weight) to HDPE (NOVATEC HB111R available from Japan Polyethylene Corporation), and melt kneading the thus obtained mixture by a twin screw extruder.

Vinyl Acetate-Modified HDPE (Component (b))

HDPE modified with vinyl acetate (modification ratio: 0.3% by weight, melting point: 129° C.) was produced by adding vinyl acetate (content: 0.3% by weight) and di-t-butyl peroxide (content: 1% by weight) to HDPE (NOVATEC HB111R available from Japan Polyethylene Corporation)i and melt kneading the thus obtained mixture by a twin screw extruder.

Amine-Modified HDPE (Comnponent (b))

HDPE modified with amine (modification ratio; 0.5% by weight, melting point; 129° C.) was produced by adding methylene diamine (content: 0.5% by weight) and di-t-butyl peroxide (content: 1% by weight) to HDPE (NOVATEC HB111R available from Japan Polyethylene Corporation), and melt kneading the thus obtained mixture by a twin screw extruder.

Maleic Anhydride-Modified LLDPE-A

LLDPE-A modified with maleic anhydride (modification ratio; 0.4% by weight, melting point: 122° C.) was produced by adding maleic anhydride (content: 0.4% by weight) and 2,5-dimethyl-2,5di(t-butyl peroxy)hexane (content: 0.015% by weight) to LLDPE (NOVATEC UE320 available from Japan Polyethylene Corporation: specific gravity; 0.922, melting point; 122° C.), and melt kneading the thus obtained mixture by a twin screw extruder.

Maleic Anhydride-Modified LLDPE-B

LLDPE-B modified with maleic anhydride (modification ratio: 0.4% by weight, melting point: 123° C.) was produced by adding maleic anhydride (content: 0.4% by weight) and 2,5-dimethyl-2,5di(t-butyl peroxy)hexane (content: 0.015% by weight) to LLDPE (NOVATEC UJ580 available from Japan Polyethylene Corporation: specific gravity; 0.925, melting point; 125° C.), and melt kneading the thus obtained mixture by a twin screw extruder.

### EXAMPLES 1 TO 28 AND COMPARATIVE EXAMPLES 1 to 14

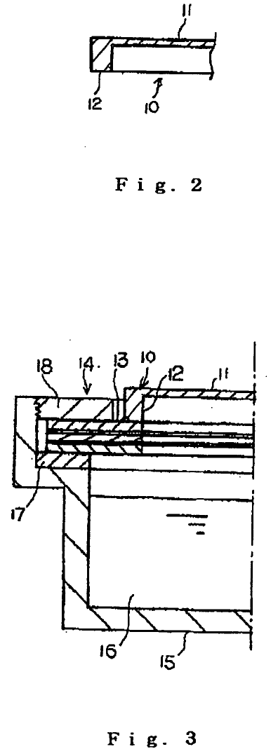

Each compound shown in Tables 2 to 7 was prepared by mixing the ingredients in proportions as shown in the same tables and kneaded by a twin screw extruder (TEX30α available from The Japan Steel Works, LTD.) at a specific temperature to produce a pellet (alloy material). Then, the pellet was put into a mold having a specific shape for injection molding to produce a test joint part 10, as shown in FIG. 2, integrally formed by a circular top portion 11 and a flange 12. FIG. 2 is a side elevational and sectional view of about a half of each test joint part. Each joint part 10 has a circular top portion 11 (corresponding to a main body 2 in FIG. 1) having a radius of 20 mm and a thickness of 0.5 mm and a flange 12 (corresponding to a welding member 3 in FIG. 1) depending from the edge of the top portion 11 and having a height of 5 mm and a wall thickness of 5 mm.

The thus obtained test joint parts for Examples and Comparative Examples were evaluated in accordance with the following characteristics. These results are also shown in the following Tables 2 to 7.

Permeation Amount of Fuel

Each of the test joint parts according to Examples 1 to 28 and Comparative Examples 1 to 14 was used to prepare a test assembly 14. Each test joint part 10 had its flange 12 welded at its bottom to a sheet material 13 for a tank by a hot-plate welding method (temperature: 260° C.) to prepare a test assembly 14, as shown in FIG. 3. The sheet material 13 was a flat and annular multilayer structure having an inside diameter equal to that of the flange 12. Its multilayer structure was similar to the resinous wall of a fuel tank, and was made by applying an adhesive resin onto both sides of an EVOH layer, laying HDPE thereon and pressing them together under heat. The flange 12 was welded at its bottom to one of the HDPE layers (corresponding to outer surface material of the resin fuel tank) of the sheet material 13.

Each test assembly was tested for fuel permeability by a method as shown in FIG. 3. A test cup 15 having a top opening and a shoulder was fed with a fuel mixture 16 prepared by mixing 90 volume % of Fuel C, or test gasoline composed of equal proportions by volume of toluene and isooctane and 10 volume % of ethanol. A rubber seal 17 was placed on the shoulder of the cup 15 and the test assembly 14 was placed on the seal 17. An annular cover 18 having a screw thread was threadedly fitted in the top opening of the cup 15 to tighten the test assembly 14 and thereby close the cup 15 tightly. The cup 15 was turned upside down, and held in an atmosphere having a temperature of 40° C., and its change in total weight was checked every day fora month as a measure for the fuel permeability of the test assembly. The measured values (permeation amount of fuel) when they were stable were used for evaluation. The results are shown in Tables 1 to 7.

Weld Strength (to Tank Material)

Each compound shown in Tables 2 to 7 was prepared by mixing the ingredients in proportions as shown in the same tables and kneaded by means of a twin screw extruder at a specific temperature to produce each pellet for Examples and Comparative Examples. Each pellet was injection molded using a mold having a halved dumbbell shape of a multipurpose dumbbell in accordance with ISO to produce a test halved dumbbell, Further, HDPE was injection molded using a mold having a halved dumbbell shape obtained by halving a multipurpose dumbbell in accordance with ISO at a right angle with a direction for tensile strength test to produce a halved dumbbell made of HDPE. The HDPE halved dumbbell was made similarly to the resinous wall of a fuel tank. The test halved dumbbell and the HDPE halved dumbbell were welded at 230° C. by hot plate welding means. The test halved dumbbell was pulled at a test speed of 50 mm/min with the HDPE halved dumbbell fixed by means of a tensile tester for determination of the maximum weld strength.

Weld Strength (to Valve Material)

Each compound shown in Tables 2 to 7 was prepared by mixing the ingredients in proportions as shown in the same tables and kneaded by means of a twin screw extruder at a specific temperature to produce each pellet for Examples and Comparative Examples. Each pellet was injection molded using a mold having a halved dumbbell shape of a multipurpose dumbbell in accordance with ISO to produce a test halved dumbbell. Further, polyamide 6 reinforced with glass fiber (PA6GF; UBE NYLON 1015GC6 available from UBE INDUSTRIES, LTD.; glass fiber (GF) content: 30% by weight) was injection molded using a mold having a halved dumbbell shape obtained by halving a multipurpose dumbbell in accordance with ISO at a right angle with a direction for tensile strength test to produce a halved dumbbell made of PA6. The PA6 halved dumbbell was made similarly to the VSF valve. The test halved dumbbell and the PA6 halved dumbbell were welded at 290° C. by hot plate welding means. The test halved dumbbell was pulled at a test speed of 50 mm/min with the PAX halved dumbbell fixed by means of a tensile tester for determination of the maximum weld strength.

Maximum Tensile Strength

The stress at an yield point or the tensile strength at break was measured by using each alloy material of Examples and Comparative Examples in accordance with ISO 527. In Tables 2 to 7, a greater value of the stress at an yield point or the tensile strength at break was shown as the maximum strength.

Dispersibility

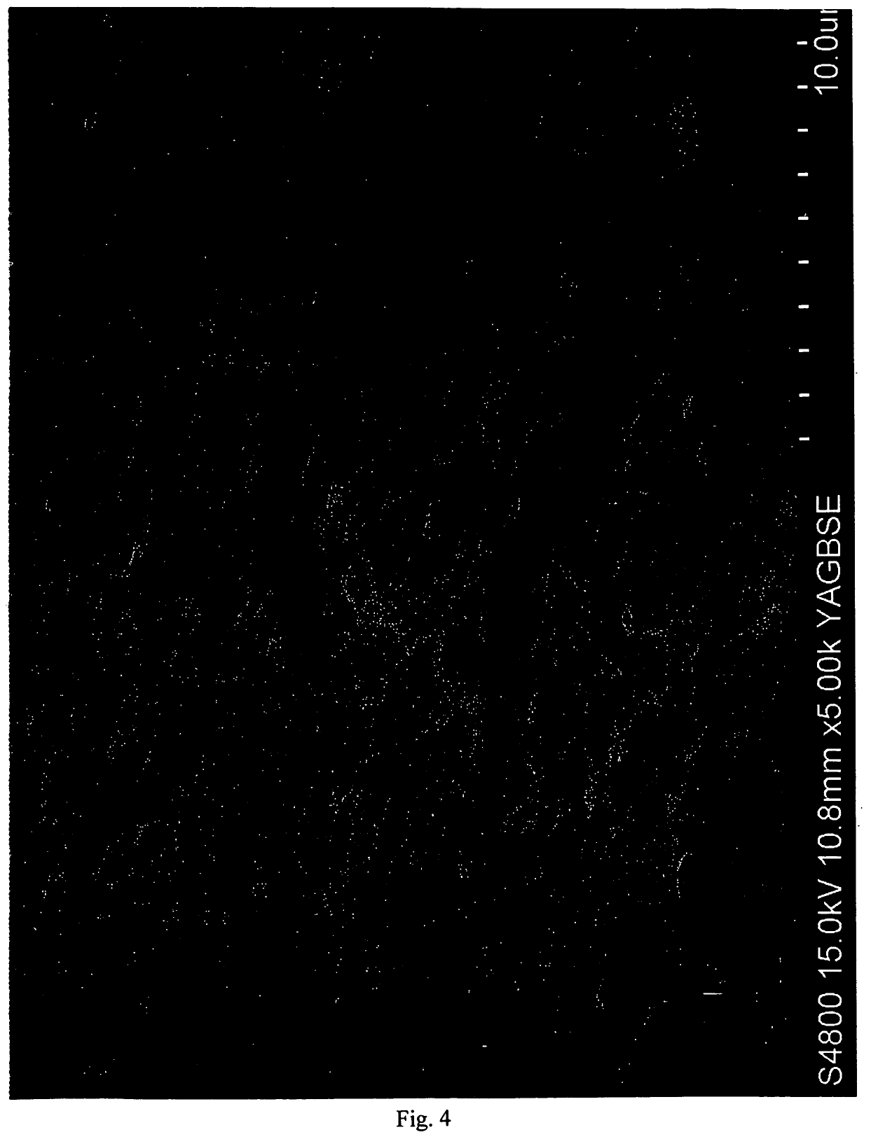

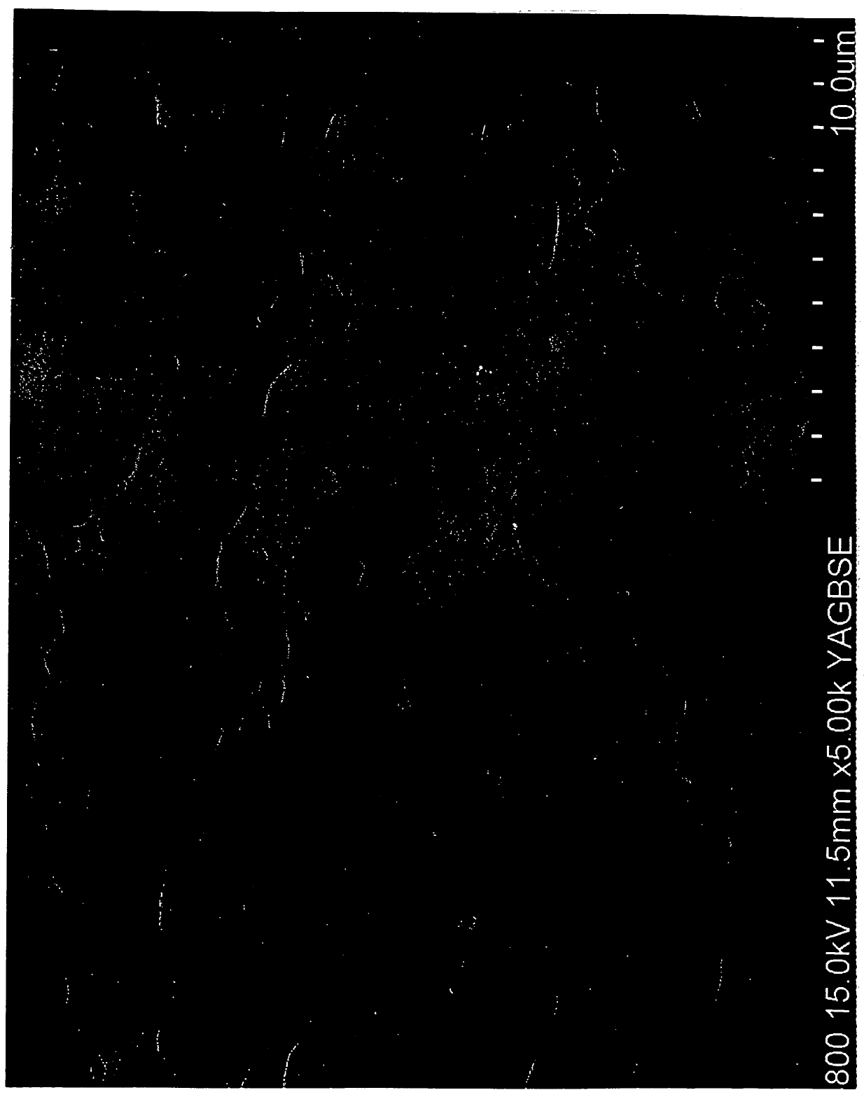

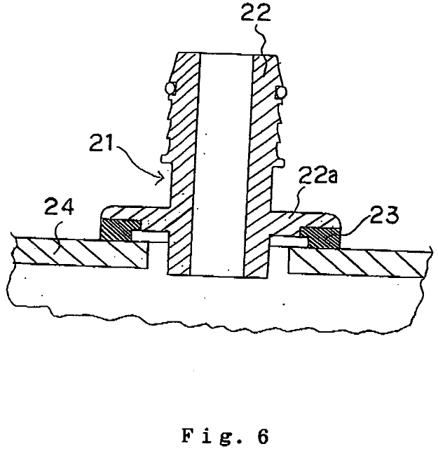

Each compound shown in Tables 2 to 7 was prepared by mixing the ingredients in proportions as shown in the same tables and kneaded by means of a twin screw extruder at a specific temperature to produce each pellet for Examples and Comparative Examples. Each dispersion state of the sea (matrix) and the island (micro particles) was observed. The diameters of micro particles were determined by means of a scanning electron microscopy (S4800 available from Hitachi Technologies Corporation). When there were variation in measured diameters, the scope of the variation was indicated. The scanning electron micrograph illustrating a morphological structure of Example 2 was shown in FIG. 4, and the scanning electron micrograph illustrating a morphological structure of Comparative Example 14 was shown in FIG. 5. From the scanning electron micrograph as shown in FIG. 4, it was found that since Example 2 was kneaded at a temperature (80° C.) not more than melting points of the EVOH and the maleic anhydride-modified HDPE, micro particles (white portion) each having a diameter of about 1 μm comprising the maleic anhydride-modified HDPE were dispersed to a matrix (black portion) comprising the EVOH. On the contrary, from the scanning electron micrograph as shown in FIG. 5, it was found that since Comparative Example 4 was kneaded at a temperature (210° C.) over melting points of the EVOH and the maleic anhydride-modified HDPE, an island-sea structure was reversed as compared with FIG. 4. That is, the maleic anhydride-modified HDPE became a matrix (black portion), while the EVOH became dispersed particles (white portion) and their diameters scattered in the range of 3 to 5 μm, which were not extremely micro particles.

TABLE 2
(parts by volume)

| | | Examples | | | | | | |
|---|---|---|---|---|---|---|---|---|
| | | 1 | 2 | 3 | 4 | 5 | 6 | 7 |
| EVOH | | 100 | 100 | 100 | 100 | 100 | 100 | 100 |
| | Type | A | A | A | A | A | A | A |
| | Ethylene proportion | 32 mol % | 32 mol % | 32 mol % | 32 mol % | 32 mol % | 32 mol % | 32 mol % |
| Maleic anhydride-modified HDPE | | 80 | 200 | 300 | 170 | 200 | 200 | 200 |
| | Type | A | A | A | A | A | A | A |
| | Modification ratio | 0.2% by | 0.2% by | 0.2% by | 0.2% by | 0.2% by | 0.2% by | 0.2% by |
| | | weight | weight | weight | weight | weight | weight | weight |
| HDPE *1 | | — | — | — | 30 | — | — | — |
| Compatibilizer *2 | | — | — | — | — | 6 | — | — |
| Compatibilizer *3 | | — | — | — | — | — | 6 | — |
| Compatibilizer *4 | | — | — | — | — | — | — | 6 |
| Kneading temperature (° C.) | | 80 | 80 | 80 | 80 | 80 | 80 | 80 |
| Permeation amount of fuel | | less than | less than | less than | less than | less than | less than | less than |
| (mg · mm/cm²/day) | | 0.1 | 0.1 | 0.1 | 0.1 | 0.1 | 0.1 | 0.1 |
| Weld strength | to tank material | 18.8 | 20.5 | 19.8 | 20.7 | 20.8 | 20.1 | 20.4 |
| (MPa) | to valve material | 42.3 | 34.2 | 28.6 | 31.2 | 33.6 | 33.4 | 34.5 |
| Maximum tensile strength (MPa) | | 44.3 | 33.0 | 27.6 | 31.3 | 31.8 | 32.0 | 32.2 |
| Dispersibility | Matrix | EVOH | EVOH | EVOH | EVOH | EVOH | EVOH | EVOH |
| | Particles | modified | modified | modified | modified | modified | modified | modified |
| | | HDPE | HDPE | HDPE | HDPE | HDPE | HDPE | HDPE |
| | Particle diameter | about 1 | about 1 | about 1 | about 1 | about 1 | about 1 | about 1 |
| | (μm) | | | | | | | |

*1: NOVATEC HB111R available from Japan Polyethylene Corporation (specific gravity; 0.95, melting point; 129° C.)
*2: Epoxy modified-SBS (EPOFRIEND AT-501 available from DAICEL CHEMICAL INDUSTRIES, LTD.)
*3: EGMA (BOND FAST E available from Sumitomo Chemical Co., Ltd.)
*4: Styrene-isopropenyl oxazoline copolymer (EPOCROS RPS-1005 available from NIPPON SHOKUBAI CO., LTD.)
*: Mixing amount of each Compatibilizer *2 to *4 is indicated by parts by weight based on 100 parts by weight of EVOH.

TABLE 3
(parts by volume)

| | | Examples | | | | | | |
|---|---|---|---|---|---|---|---|---|
| | | 8 | 9 | 10 | 11 | 12 | 13 | 14 |
| EVOH | | 100 | 100 | 100 | 100 | 100 | 100 | 100 |
| | Type | A | A | A | A | A | A | A |
| | Ethylene proportion | 32 mol % | 32 mol % | 32 mol % | 32 mol % | 32 mol % | 32 mol % | 32 mol % |
| Maleic anhydride-modified HDPE | | 200 | 200 | 200 | — | — | — | — |
| | Type | A | B | C | — | — | — | — |
| | Modification ratio | 0.2% by | 0.1% by | 5% by | — | — | — | — |
| | | weight | weight | weight | | | | |
| Modified HDPE | Maleic acid-modified | — | — | — | 200 | — | — | — |
| | Acrylic acid- | — | — | — | — | 200 | — | — |
| | modified | | | | | | | |
| | Methacrylic acid- | — | — | — | — | — | 200 | — |
| | modified | | | | | | | |
| | Ester acrylate- | — | — | — | — | — | — | 200 |
| | modified | | | | | | | |
| | Modification ratio | — | — | — | 0.3% by | 0.3% by | 0.3% by | 0.3% by |
| | | | | | weight | weight | weight | weight |
| E-glass fiber *1 | | 100 | — | — | — | — | — | — |
| Kneading temperature (° C.) | | 80 | 80 | 80 | 80 | 80 | 80 | 80 |
| Permeation amount of fuel | | less than | less than | 1.2 | less than | less than | less than | less than |
| (mg · mm/cm²/day) | | 0.1 | 0.1 | | 0.1 | 0.1 | 0.1 | 0.1 |
| Weld strength | to tank material | 19.5 | 20.2 | 20.4 | 20.4 | 20.1 | 19.5 | 20.4 |
| (MPa) | to valve material | 32.6 | 25.6 | 40.3 | 27.3 | 23.7 | 23.4 | 26.3 |
| Maximum tensile strength (MPa) | | 80.5 | 33.5 | 28.3 | 32.8 | 33.4 | 33.0 | 32.5 |
| Dispersibility | Matrix | EVOH | EVOH | EVOH | EVOH | EVOH | EVOH | EVOH |
| | Particles | modified | modified | modified | modified | modified | modified | modified |
| | | HDPE | HDPE | HDPE | HDPE | HDPE | HDPE | HDPE |
| | Particle diameter (μm) | about 1 | about 1 | about 1 | about 1 | about 1 | about 1 | about 1 |

*1: Mixing amount of E-glass fiber is indicated by parts by weight based on 100 parts by weight of EVOH.

TABLE 4
(parts by volume)

| | | Examples | | | | | | |
|---|---|---|---|---|---|---|---|---|
| | | 15 | 16 | 17 | 18 | 19 | 20 | 21 |
| EVOH | | 100 | 100 | 100 | 100 | 100 | 100 | 100 |
| | Type | A | A | A | A | A | A | B |
| | Ethylene proportion | 32 mol % | 32 mol % | 32 mol % | 32 mol % | 32 mol % | 32 mol % | 38 mol % |
| Modified HDPE | Ester methacrylate- | 200 | — | — | — | — | — | — |
| | modified | | | | | | | |
| | Vinyl acetate- | — | 200 | — | — | — | — | — |
| | modified | | | | | | | |
| | Amine-modified | — | — | 200 | — | — | — | — |
| | Modification ratio | 0.3% by | 0.3% by | 0.5% by | — | — | — | — |
| | | weight | weight | weight | | | | |
| Maleic anhydride-modified HDPE | | — | — | — | 200 | 150 | 100 | 200 |
| | Type | — | — | — | D | D | D | D |
| | Modification ratio | — | — | — | 0.4% by | 0.4% by | 0.4% by | 0.4% by |
| | | | | | weight | weight | weight | weight |
| Kneading temperature (° C.) | | 80 | 80 | 80 | 80 | 80 | 80 | 80 |
| Permeation amount of fuel | | less than | less than | less than | less than | less than | less than | less than |
| (mg · mm/cm²/day) | | 0.1 | 0.1 | 0.1 | 0.1 | 0.1 | 0.1 | 0.1 |
| Weld strength | to tank material | 19.9 | 20.1 | 20.3 | 19.5 | 19.4 | 37.3 | 19.7 |
| (MPa) | to valve material | 28.3 | 24.6 | 34.6 | 29.1 | 35.4 | 43.6 | 32.1 |
| Maximum tensile strength (MPa) | | 32.9 | 32.0 | 32.1 | 34.2 | 33.8 | 42.4 | 31.9 |
| Dispersibility | Matrix | EVOH | EVOH | EVOH | EVOH | EVOH | EVOH | EVOH |
| | Particles | modified | modified | modified | modified | modified | modified | modified |
| | | HDPE | HDPE | HDPE | HDPE | HDPE | HDPE | HDPE |
| | Particle diameter | about 1 | about 1 | about 1 | about 1 | about 1 | about 1 | about 1 |
| | (μm) | | | | | | | |

TABLE 5
(parts by volume)

| | | Examples | | | | | | |
|---|---|---|---|---|---|---|---|---|
| | | 22 | 23 | 24 | 25 | 26 | 27 | 28 |
| EVOH | | 100 | 100 | 100 | 100 | 100 | 100 | 100 |
| | Type | C | D | E | F | F | A | A |
| | Ethylene proportion | 44 mol % | 47 mol % | 32 mol % | 27 mol % | 27 mol % | 32 mol % | 32 mol % |
| Maleic anhydride-modified HDPE | | 200 | 200 | 200 | 200 | 100 | 200 | 200 |
| | Type | D | D | D | D | D | D | D |
| | Modification ratio | 0.4% by | 0.4% by | 0.4% by | 0.4% by | 0.4% by | 0.4% by | 0.4% by |
| | | weight | weight | weight | weight | weight | weight | weight |
| Kneading temperature (° C.) | | 80 | 80 | 80 | 80 | 80 | 60 | 100 |
| Permeation amount of fuel | | less than | less than | less than | less than | less than | less than | less than |
| (mg · mm/cm²/day) | | 0.1 | 0.1 | 0.1 | 0.1 | 0.1 | 0.1 | 0.1 |
| Weld strength | to tank material | 19.3 | 19.3 | 19.6 | 17.4 | 17.8 | 19.2 | 19.6 |
| (MPa) | to valve material | 29.6 | 25.7 | 28.6 | 25.6 | 28.6 | 28.5 | 28.7 |
| Maximum tensile strength (MPa) | | 31.0 | 31.0 | 34.9 | 27.0 | 44.8 | 34.5 | 32.3 |
| Dispersibility | Matrix | EVOH | EVOH | EVOH | EVOH | EVOH | EVOH | EVOH |
| | Particles | modified | modified | modified | modified | modified | modified | modified |
| | | HDPE | HDPE | HDPE | HDPE | HDPE | HDPE | HDPE |
| | Particle diameter | about 1 | about 1 | about 1 | about 1 | about 1 | about 1 | about 1 |
| | (μm) | | | | | | | |

TABLE 6
(parts by volume)

| | | Comparative Examples | | | | | | |
|---|---|---|---|---|---|---|---|---|
| | | 1 | 2 | 3 | 4 | 5 | 6 | 7 |
| EVOH | | 100 | 100 | 100 | 100 | 100 | 100 | 100 |
| | Type | A | A | A | A | A | A | A |
| | Ethylene proportion | 32 mol % | 32 mol % | 32 mol % | 32 mol % | 32 mol % | 32 mol % | 32 mol % |
| Maleic anhydride-modified HDPE | | 50 | 350 | — | — | — | 200 | — |
| | Type | A | A | — | — | — | a | — |
| | Modification ratio | 0.2% by | 0.2% by | — | — | — | 6% by | — |
| | | weight | weight | | | | weight | |
| HDPE *1 | | — | — | 200 | — | — | — | — |
| Maleic anhydride-modified LDPE *2 | | — | — | — | 100 | — | — | — |
| LDPE *3 | | — | — | — | — | 100 | — | — |
| Maleic anhydride-modified LLDPE | | — | — | — | — | — | — | 100 |
| | Type | — | — | — | — | — | — | A |
| | Modification ratio | — | — | — | — | — | — | 0.4% by |
| | | | | | | | | weight |
| Kneading temperature (° C.) | | 80 | 80 | 80 | 210 | 210 | 80 | 210 |
| Permeation amount of fuel | | less than | 5.3 | 8.3 | 16.3 | 73.2 | 4.6 | 16.8 |
| (mg · mm/cm²/day) | | 0.1 | | | | | | |
| Weld strength | to tank material | 12.5 | 20.6 | 20.7 | 16.7 | 13.3 | 20.1 | 20.4 |
| (MPa) | to valve material | 47.5 | 22.8 | 5.6 | 23.8 | 9.6 | 30.1 | 18.2 |
| Maximum tensile strength (MPa) | | 56.2 | 23.1 | 27.7 | 17.5 | 13.6 | 25.8 | 32.2 |
| Dispersibility | Matrix | EVOH | modified | EVOH | EVOH | EVOH | EVOH | EVOH |
| | | | HDPE | | | | | |
| | Particles | modified | EVOH | modified | modified | LDPE | modified | modified |
| | | HDPE | | HDPE | LDPE | | HDPE | LLDPE |
| | Particle diameter | about 1 | about 1 | 5-50 | 5-100 | 5-100 | about 1 | 5-100 |
| | (μm) | | | | | | | |

*1: NOVATEC HB111R available from Japan Polyethylene Corporation (specific gravity; 0.95, melting point; 129° C.)
*2: ADMER LB548 available from Mitsui Chemicals, Inc. (modification ratio: 0.2% by weight, melting point: 110° C.)
*3: NOVATEC LC605Y available from Japan Polyethylene Corporation (specific gravity; 0.92, melting point; 106° C.)

TABLE 7
(parts by volume)

| | | Comparative Examples | | | | | | |
|---|---|---|---|---|---|---|---|---|
| | | 8 | 9 | 10 | 11 | 12 | 13 | 14 |
| EVOH | | 100 | 100 | 100 | 100 | 100 | 100 | 100 |
| | Type | A | E | E | C | A | A | A |
| | Ethylene proportion | 32 mol % | 32 mol % | 32 mol % | 44 mol % | 32 mol % | 32 mol % | 32 mol % |
| Maleic anhydride-modified HDPE | | — | 350 | 50 | 50 | — | 30 | 200 |
| | Type | — | D | D | D | — | D | D |
| | Modification ratio | — | 0.4% by | 0.4% by | 0.4% by | — | 0.4% by | 0.4% by |
| | | | weight | weight | weight | | weight | weight |
| Maleic anhydride-modified LLDPE | | 100 | — | — | — | — | — | — |
| | Type | B | — | — | — | — | — | — |
| | Modification ratio | 0.4% by | — | — | — | — | — | — |
| | | weight | | | | | | |
| HDPE *1 | | — | — | — | — | 100 | 170 | — |
| Kneading temperature (° C.) | | 210 | 80 | 80 | 80 | 80 | 80 | 210 |
| Permeation amount of fuel | | 17.3 | 15.8 | less than | less than | 2.0 | 0.3 | 17.7 |
| (mg · mm/cm²/day) | | | | 0.1 | 0.1 | | | |
| Weld strength | to tank material | 19.5 | 17.6 | 0.0 | 0.0 | 9.4 | 10.6 | 17.9 |
| (MPa) | to valve material | 17.6 | 22.6 | 54.2 | 47.6 | 10.8 | 5.8 | 25.7 |
| Maximum tensile strength (MPa) | | 80.5 | 25.2 | 32.5 | 32.9 | 45.1 | 32.1 | 27.8 |
| Dispersibility | Matrix | EVOH | modified | EVOH | EVOH | EVOH | EVOH | modified |
| | | | HDPE | | | | | HDPE |
| | Particles | modified | EVOH | modified | modified | HDPE | *2 | EVOH |
| | | LLDPE | | HDPE | HDPE | | | |
| | Particle diameter | 5-100 | about 1 | about 1 | about 1 | about 1 | 5-50 | 3-5 |
| | (μm) | | | | | | | |

*1: NOVATEC HB111R available from Japan Polyethylene Corporation (specific gravity; 0.95, melting point; 129° C.)
*2: HDPE and modified HDPE formed particles.

The results show that each permeation amount of fuel was low in Examples, and thus Examples were excellent in low fuel permeability. They also show that each weld strength (both to tank material and valve material) of Examples was remarkably high.

The reason therefor is not clear but is thought to be as follows.

1) Welding to Tank Material (HDPE)

Generally, the tank material (HDPE) is welded to polyethylene resins such as HDPE or modified HDPE, but is not welded to the EVOH. On the other hand, since Examples were each mainly composed of the EVOH and the modified HDPE, Examples had increased compatibility (including adhesion) with the EVOU and the modified HOPE. Due to the compatibility and the control of kneading, the diameters of dispersed particles comprising the modified HDPE became extremely small (about 1 μm) and the particles were almost evenly dispersed in the matrix comprising the EVOH. For this reason, the modified HDPE having a lower melting point is thought to be dissolved in hot-plate welding and was welded to the tank material.

2) Welding to Valve Material (GF-Containing PA)

Generally, the valve material (GF-containing PA) is welded to modified HDPE, but is not welded to non-modified .polyethylene resin. On the other hand, Examples were each mainly composed of the modified HDPE and the EVOH, both which are welded to PA, and that the amount for use of non-modified polyethylene resin, which is not welded to PA, was minimized in Examples. For this reason, Examples are thought to be welded to the valve material (GF-containing PA).

On the contrary, since the mixing ratio of maleic anhydride-modified HDPE-A was less than the lower limit in Comparative Example 1, the weld strength was low. Since the mixing ratio of maleic anhydride-modified HOPE-A was over the upper limit in Comparative Example 2, the permeation amount of fuel was increased, and thus low fuel permeability was inferior, and also weld strength was low. Since non- modified HDPE was used instead of the modified HDPE in Comparative Example 3, the permeation amount of fuel was increased and thus low fuel permeability was remarkably inferior. Since maleic anhydride-modified LDPE was used instead of the modified HDPE in Comparative Example 4, the permeation amount of fuel was increased, and thus low fuel permeability was remarkably inferior, and also weld strength was low. Since non-modified LDPE was used instead of the modified HDPE in Comparative Example 5, low fuel permeability was remarkably inferior and also weld strength was remarkably low. Since maleic anhydride-modified HDPE-a having a modification ratio exceeding the upper limit was Comparative Example 6, low fuel permeability was inferior. Since maleic anhydride-modified LLDPE was used instead of the modified HDPE each in Comparative Examples 7 and 8, low fuel permeability was remarkably inferior. Since the mixing ratio of maleic anhydride-modified HDPE-D was over the upper limit in Comparative Example 9, the EVOH formed particles, not matrix, and an island-sea structure was reversed as compared with Examples. For this reason, permeation amount of fuel was remarkably increased and thus low fuel permeability was remarkably inferior. Since the mixing ratio of maleic anhydride-modified HDPE-D was less than the lower limit each in Comparative Examples 10 and 11, interface separation occurred only when the weld product with the tank material was lifted. Since non-modified HDPE was used instead of the modified HDPE in Comparative Example 12, permeation amount of fuel was increased and thus low fuel permeability was inferior. Since the mixing ratio of maleic anhydride-modified HDPE-D was less than the lower limit and a great amount of HDPE was included in Comparative Example 13, variation in diameters of particles was great. Since kneading was conducted at a temperature exceeding the melting points of the EVOH and the maleic anhydride-modified HDPE in Comparative Example 14, an island-sea structure was reversed as compared with Examples, diameters of particles were large and low fuel permeability was remarkably inferior.

The joint part of the present invention may be applicable for, for example, fuel filler and ORVR valves, VSF (Vent Shaft Float) valve, V-return valve, but are not limited to valve type parts. Pipes for connecting hoses are applicable, too.

What is claimed is:

1. A joint part for a resin fuel tank comprising a cylindrical main body and a welding member to be welded to a rim of an opening end of the resin fuel tank, wherein the main body and the welding member are integrally formed for forming the joint part by an alloy prepared by using main components of following components (A) and (B) and kneading the alloy at a temperature of not more than melting points of the component (A) and a following component (b), and the component (B) is present at an amount of 80 to 300 parts by volume based on 100 parts by volume of the component (A), and a modification ratio of the component (b) is 0.1 to 5% by weight;
(A) an ethylene vinyl alcohol copolymer
(B) a high density polyethylene wherein thefollowing component (b) is a main component;
(b) a modified high density polyethylene having at least one functional group selected from the group consisting of a maleic anhydride group, a maleic acid group, an acrylic acid group, a methacrylic acid group, an acrylate ester group, a methacrylate ester group, a vinyl acetate group and an amino group.

2. A joint part according to claim 1, wherein the alloy further contains an inorganic filler.

3. A joint part according to claim 2, wherein the inorganic filler is glass fiber.

4. A joint part according to claim 1, wherein the alloy further contains a compatibilizer.

5. A joint part according to claim 1, wherein stress at yield point or tensile strength at break is not less than 20 MPa.

6. A joint part according to claim 1, wherein the alloy has an island-sea structure wherein micro particles comprising the component (b) are evenly dispersed in a matrix comprising the component (A).

7. A joint part according the claim 6, wherein the micro particles each have approximately a diameter of 1 μm.

8. A method for manufacturing a joint part according to claim 1, comprising the steps of
preparing an alloy consisting essentially of a following component (A) and a following component (B),
kneading the prepared alloy with shearing at not more than melting points of the component (A) and a following component (b);
(A) an ethylene vinyl alcohol copolymer
(B) a high density polyethylene wherein the following component (b) is a main component;
(b) a modified high density polyethylene having at least one functional group selected from the group consisting of a maleic anhydride group, a maleic acid group, an acrylic acid group, a methacrylic acid group, an acrylate ester group, a methacrylate ester group, a vinyl acetate group and an amino group.
